(19) United States
(12) Patent Application Publication
(10) Pub. No.: US 2004/0147427 A1
(43) Pub. Date: Jul. 29, 2004

(54) Rinse aid containing encapsulated glasscare active salt

(75) Inventors: Leslie Dawn Waits, Cincinnati, OH (US); Anju Deepali Brooker, Newcastle Upon (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/714,222

(22) Filed: Nov. 14, 2003

Related U.S. Application Data
(60) Provisional application No. 60/426,429, filed on Nov. 14, 2002.
(60) Provisional application No. 60/459,390, filed on Apr. 1, 2003.

(51) Int. Cl. C11D 1/00

(52) U.S. Cl. 510/521; 510/220

(57) ABSTRACT

A rinse aid composition is disclosed in one embodiment comprising: (a) an encapsulated glasscare active salt; (b) at least one rinse aid component; and (c) optionally an adjunct material.

### PRIORITY

This application claims priority to U.S. Provisional Application No. 60/426,429, filed Nov. 14, 2002 and U.S. Provisional Applicatin No. 60/459,930 filed Apr. 1, 2003.

### FIELD OF INTEREST

The present invention is in the field of dishwashing, in particular it relates to dishwashing and automatic dishwashing products, auxiliaries and methods suitable for rinsing and protecting glassware.

### BACKGROUND

Odor, spotting, filming and corrosion of glassware in automatic dishwashing are well known problems that continually plague consumers. Consumers demand better end results. They desire better smelling products with less glassware spotting and filming. They want better shine with improved corrosion protection. Most consumers agree that corrosion of glassware in automatic dishwashing is one of their most serious unmet needs. Though when compared to main wash detergent products alone, some current rinse aid products may deliver better spotting and filming performance with the use of dispersant polymers in combination with nonionic surfactants, however, they do not protect against glassware corrosion.

Compositions comprising water-soluble metal salts (such as zinc salts of chloride, sulfate or acetate) for use in dishwashing afford some measure of glassware protection. Water-soluble zinc salt may be employed to prevent the corrosion of ceramic surfaces. Solid metal plates of zinc alloys may also be used in combination with a rinse aid composition to provide corrosion protection to glassware. A water-soluble zinc salt may even be used in conjunction with a low-foaming nonionic surfactant in neutral to high pH. However, the use of this high pH composition in automatic dishwashing can result in unsatisfactory filming and precipitation of insoluble materials. Such precipitant material is very undesirable as it can adhere to internal dishwasher parts, as well as, onto dish- and glassware during the washing cycle. One alternative to reducing precipitate formation is achieved by carefully adjusting the levels and proportions of various components in product formulation. This method requires strict formulation controls and is costly. Another alternative to reduce precipitate formation is achieved by spraying a solution of the water-soluble zinc salt onto granular polyphosphate particles. Another alternative using soluble zinc and a chelant provides some glassware corrosion protection but has a filming negative (i.e. crystals and films formed on glassware). Yet another alternative is to use insoluble zinc salt to control the release of the zinc ion in the rinse to avoid filming. However, there are disadvantages of using insoluble materials in the liquid rinse aid formulations. The product would be cloudy and it requires particular thickeners and stabilizers which may hinder delivery of the product from the rinse aid dispenser to the rinse liquor.

A cost effective and simple approach to reducing glassware corrosion is to provide a glasscare active salt, for example an aluminum salt such as aluminum sulfate, to the rinse aid composition. However, there are several drawbacks to this approach. For example, soluble (or slightly soluble) glasscare active salts can cause phase separation in certain liquids.

Encapsulation is known. A variety of materials and methods can be used to coat particles. The majority of the encapsulation effort, however, has been directed to bleach and enzyme encapsulation. In particular, bleach and enzyme particles can be single-coated with fatty acids, polyvinyl alcohol or polyethylene glycols or double-coated with an inner coat of paraffin or microcrystalline waxes having melting points of 40°-94° C. and a second coat of material such as sodium carbonate. Alternatively, the double-coated encapsulated bleach and enzyme particles may have an inner coat of fatty acid or waxes and an outer coat of water-soluble cellulose ether. Other encapsulating coatings for bleach and enzyme particles include polymer latex; polycarboxylate materials; polyethylene waxes of melting point 50°-65° C.; and various other waxes. The bleach and enzyme particles may also be coated with ethylene vinyl acetate, fatty acid, natural waxes, a synthetic resin or an inorganic coating. For example, the bleach and enzyme particles may be coated with silicone oil, petroleum jelly or alcohol waxes. Some precursor particles used in cleaning compositions have also been encapsulated with liquid paraffin waxes and polyvinyl alcohol.

It has surprisingly been found that by protecting certain glasscare active salts from dissolving in (or reacting with) the liquid rinse aid composition, good glassware corrosion protection can be achieved during the rinsing cycle of an automatic dishwashing appliance. The drawback of interaction of the glasscare active salts with rinse aid components can be minimized in liquids and solids (e.g. powders and tablets) by use of encapsulated glasscare active salts. The release of the encapsulated glasscare active salt can be delayed or sequenced depending on the type of encapsulating coating used.

### SUMMARY OF THE INVENTION

A rinse aid is disclosed that comprises: (a) from about 0.01% and about 70%, by weight of the composition of a glasscare active salt; (b) at least one rinse aid component; and (c) optionally an adjunct material. The glasscare active salt is at least partially encapsulated via at least one encapsulating agent, which provides at least one encapsulating coating to a glasscare active salt. The rinse aid may in any form including, but not limited to, liquid, liquid gel, gel, paste, cream, cast solid, powder, tablet, and mixtures thereof. In at least one embodiment, glassware is protected from corrosion and fading. The combination of the rinse aid composition with a method, and a kit are also disclosed herein.

### DETAILED DESCRIPTION OF THE INVENTION

Glasscare Active Salt

A rinse aid is disclosed herein that comprises an encapsulated glasscare active salt (hereinafter “EGAS composition”) comprising aluminum, zinc, magnesium, calcium, lanthanum, tin, gallium, strontium, titanium, and mixtures thereof. Any convenient water-soluble or water-insoluble glasscare active salt can be used herein. The glasscare active salt may be in the form of a core particle, aggregate of core particles, prill, agglomerate, and mixtures thereof. These forms may be nonfriable for handling during processing and when used by consumers. They may also be water-soluble, or water dispersible, or they may dissolve, disperse or melt in a temperature range of from about 40° C. to about 50° C.

The glasscare active salt may be generally incorporated in an EGAS composition in any suitable amount. In some embodiments, the EGAS composition may deliver from about 0.1 mM to about 10 mM, about 0.5 mM to about 5 mM, or about 1 mM to 2 mM of the glasscare active salt or complex in the wash and/or rinse liquor. In one embodiment, the level of glasscare active salt that achieves a glassware protection benefit may be an amount between from about 0.01% and about 70%, by weight of the composition.

In one non-limiting embodiment, the EGAS composition may comprise an encapsulated aluminum salt comprising water-soluble aluminum salt, water-insoluble aluminum salt, slightly water-soluble aluminum salt, and mixtures thereof.

Water-soluble aluminum salts include, but are not limited to: aluminum acetate, aluminum ammonium sulfate, aluminum chlorate, aluminum chloride, aluminum chloride hydrate, aluminum chlorohydrate, aluminum diformate, aluminum formoacetate, aluminum monostearate, aluminum lactate, aluminum nitrate, aluminum sodium sulfate, aluminum sulfate, aluminum stearate, aluminum tartrate, aluminum triformate, sodium aluminate, and mixtures thereof. Water-insoluble or slightly soluble aluminum salts include aluminum acetylacetonate, aluminum bromide, aluminum-n-butoxide, aluminum fluoride, aluminum fluosilicate, aluminum oxylate, aluminum oxide, aluminum phosphate, aluminum salicylate, and mixtures thereof. Slow dissolving aluminum salts include, but are not limited to: aluminum stearate, aluminum tartrate, aluminum acetate, aluminum acetotartrate, aluminum salicylate, aluminum bis(acetylsalicylate), aluminum formate, aluminum octoate, aluminum borate, aluminum oleate, aluminum palmitate, aluminum acetylacetonate, aluminum phosphate, and mixtures thereof.

In another non-limiting embodiment, the EGAS composition may comprise an encapsulated zinc salt comprising water-soluble zinc salt, water-insoluble zinc salt, slightly water-soluble zinc salt, and mixtures thereof.

Water-soluble zinc salts include, but are not limited to: zinc bromate, zinc bromide, zinc chloride, zinc chloroiodide, zinc formate, zinc gluconate, zinc hydrosulfite, zinc iodide, zinc malate, zinc permanganate, zinc sulfate, zinc sulfate monohydrate, zinc sulfamate, zinc thiocyanate, and mixtures thereof. The less water-soluble zinc salts include, but are not limited to: zinc bacitracin, zinc borate, zinc carbonate, zinc basic carbonate (approximately Zn2 (OH)2 CO3), zinc fluoride, zinc fluorosilicate, zinc hydroxide, zinc laurate, zinc monophosphate (Zn3 (PO4)2), zinc oxalate, zinc oxide, zinc perborate, zinc peroxide, zinc phosphate, zinc pyrophosphate (Zn2(P2O7)), zinc resinate, zinc silicate, zinc stearate, zinc sulfide, zinc sulfite, zinc zirconium silicate, and mixtures thereof.

In another non-limiting embodiment, the EGAS composition may comprise an encapsulated magnesium salt comprising water-soluble magnesium salt, water-insoluble magnesium salt, slightly water-soluble magnesium salt, and mixtures thereof.

Water-soluble magnesium salts include, but are not limited to: magnesium acetate, magnesium acetylacetonate, magnesium ammonium phosphate, magnesium benzoate, magnesium biophosphate, magnesium borate, magnesium borocitrate, magnesium bromate, magnesium bromide, magnesium calcium chloride, magnesium chlorate, magnesium chloride, magnesium citrate, magnesium dichromate, magnesium fluosilicate, magnesium formate, magnesium gluconate, magnesium glycerophosphate, magnesium lauryl sulfate, magnesium nitrate, magnesium perchlorate, magnesium permanganate, magnesium salicylate, magnesium stannate, magnesium stannide, magnesium sulfate, and mixtures thereof. The less water-soluble magnesium salts include, but are not limited to: magnesium carbonate, magnesium chromate, magnesium fluoride, magnesium oleate, magnesium palmitate, magnesium perborate, magnesium phosphate, magnesium pyrophosphate, magnesium silicate, magnesium stearate, magnesium sulfite, magnesium trisilicate, magnesium tungstate, magnesium zirconium silicate, and mixtures thereof.

In another non-limiting embodiment, the EGAS composition may comprise an encapsulated calcium salt comprising water-soluble calcium salt, water-insoluble calcium salt, slightly water-soluble calcium salt, and mixtures thereof.

Water-soluble calcium salts include, but are not limited to: calcium acetate, calcium acetylsalicylate, calcium acrylate, calcium ascorbate, calcium borate, calcium bromate, calcium bromide, calcium chlorate, calcium chloride, calcium cyclamate, calcium dehydroacetate, calcium dichromate, calcium disodim edetate, calcium ethylhexoate, calcium formate, calcium gluconate, calcium iodate, calcium nitrite, calcium pantothenate, calcium perborate, calcium perchlorate, calcium permanganate, calcium propionate, calcium tartate, and calcium thiocynnate, and mixtures thereof. The less water-soluble calcium salts include, but are not limited to: calcium alginate, calcium biophosphate, calcium carbonate, calcium chromate, calcium citrate, calcium fluoride, calcium glycerophosphate, calcium iodobehenate, calcium iodobehenate, calcium metasilicate, calcium oleate, calcium oxalate, calcium palmitate, calcium phosphate, calcium phosphite, calcium phytate, calcium pyrophosphate, calcium resinate, calcium silicate, calcium sorbate, calcium stearate, calcium steary lactyalate, calcium sulfate, calcium sulfite, calcium thioglycollate, calcium tungstate, calcium zirconium silicate, and mixtures thereof.

Alternatively, water-soluble or water-insoluble salts comprising lanthanum, tin, gallium, strontium, titanium, and combinations thereof may also be used.

Encapsulating Agents

The encapsulating agents disclosed herein may provide at least one encapsulating coating to a glasscare active salt core particle, aggregate of core particles, prill, agglomerate, and mixtures in any suitable thickness. The at least one encapsulating coating may comprise a single-coat, multiple-coats, and combinations thereof in any suitable thickness. Encapsulating agents include, but are not limited to, fatty acids, polyvinyl alcohol, polyethylene glycols, builders, water-soluble cellulose and/or cellulose ether, polymers, polymer latex; polycarboxylate materials, ethylene vinyl acetate, polyvinyl alcohol, polyethylene waxes of melting point 50°-65° C., natural waxes, paraffin or microcrystalline waxes having melting points of 40°-94° C., liquid paraffin waxes, alcohol waxes, synthetic resin, silicone oil, petroleum jelly, inorganic coatings, and mixtures thereof.

In one non-limiting embodiment, the at least one encapsulating agent may comprise polymers, polymer latex, polycarboxylate materials, ethylene vinyl acetate, polyvinyl alcohol, and mixtures thereof. In other non-limiting embodiments, when the EGAS composition is in the form of a cast solid, powder, and mixtures thereof, the at least one encapsulating coating is substantially free of low critical solution temperature polymers. For example, low critical solution temperature polymers include those selected from the group consisting of alkylated and/or hydroxyalkylated polysaccharides, cellulose ethers, polyisoproplylacrylamine, copolymers of polyisopropylacrylamide, and mixtures thereof.

In an alkaline or highly alkaline environment, encapsulation decreases the chemical degradation of the glasscare active salt prior to its release. Encapsulated glasscare active salts also provide product stability in rinse aid compositions by inhibiting negative interaction of the glasscare active salt with other rinse aid components. This is especially true for solid rinse aid compositions. Non-encapsulated glasscare active salts will interact negatively with polymers (i.e. polyacrylates) and bleaches. Since the encapsulating agent is designed to provide a releasable coating which surrounds the glasscare active salt, neither the encapsulating agent nor the release mechanism need to be the same for any type or form of the EGAS composition. Nonetheless, the encapsulated glasscare active salt comprising at least one encapsulating coating should be stable in the product matrix (i.e. cast solid, liquid, gel, tablet and/or powder) provided and also be designed to allow for the release of the glasscare active salt by dissolution and/or disruption of the at least one encapsulating coating upon triggering by a specific active release mechanism.

The following references disclose a wide variety of encapsulating methods and materials: U.S. Pat. No. 5,824,630; U.S. Pat. No. 5,783,541; U.S. Pat. No. 5,776,874; U.S. Pat. No. 5,747,438; U.S. Pat. No. 6,462,012; U.S. Pat. No. 6,440,918; U.S. Pat. No. 6,432,902; PCT Pub. No. WO 02060998A2; PCT Pub. No. WO 02060980A2; PCT Pub. No. WO 02060758A1; PCT Pub. No. WO 0242408A2; PCT Pub. No. WO 0208373A1; PCT Pub. No. WO 0188076A1; PCT Pub. No. WO 0187360A3; PCT Pub. No. WO 0183668A1; U.S. Pat. No. 6,207,632; PCT Pub. No. WO 0102529A1; PCT Pub. No. WO 0063342A1; PCT Pub. No. WO 0063341A1; PCT Pub. No. WO 0063335A1; PCT Pub. No. WO 0055288A1; PCT Pub. No. WO 0050552A1; PCT Pub. No. WO 0041522A3; U.S. Pat. No. 6,083,892; PCT Pub. No. WO 0034429A1; PCT Pub. No. WO 0014298A1; PCT Pub. No. WO 0006687A1; PCT Pub. No. WO 9914303A1; PCT Pub. No. WO 9903512A2; PCT Pub. No. WO 9813451A1; PCT Pub. No. WO 9813449A1; PCT Pub. No. WO 9811190A1; and PCT Pub. No. WO 9811186A1.

Active Release Mechanism

The encapsulated glasscare active salt may be released from the at least one encapsulating coating at any time and by any means. For example, the encapsulated glasscare active salt may be released at a specific time after beginning the rinse, at a specific pH, at a specific rinse liquor concentration, or during or after a specific phase or activity (e.g. wash cycle) has occurred. The release of the glasscare active salt may be accomplished by the dissolution and/or disruption of the encapsulating agent or coating that surrounds the glasscare active salt. The delay or sequencing of the release of the glasscare active salt can be triggered via a number of release mechanisms including, but not limited to, time, temperature, hardness, interfacial tension, pH-sensitive, mechanical action, ionic strength, dilution, and combinations thereof.

A. Timed Release

In one non-limiting embodiment, the glasscare active salt release mechanism is by timed release. A timed release relates to a coating that disintegrates mainly as a function of time. However, a timed release does not account for different rinse durations or different rinse temperatures. A second outer coating may be provided to allow greater control of the release of the glasscare active salt.

B. Temperature Release

In another non-limiting embodiment, the glasscare active salt is released by a specific temperature or temperature range common to automatic dishwashing operations. A temperature release mechanism may comprise a coating that remains intact during the warm main wash but disintegrates during cold rinses. U.S. Pat. No. 4,765,916 discloses the use of multiple films (e.g. comprising a layer of PVA film and a layer of cellulose ether film) as a way of increasing the sensitivity of pouches designed to release in the rinse cycle. Films comprising cellulose ethers (e.g. HPMC, HBMC, and mixtures thereof) decrease in water-solubility as the temperature increases, making them more soluble in rinse water than during the warm main wash. Premature dissolution at low wash temperatures may require a second outer coating to prevent exposure of the glasscare active salt until after warm up.

C. Hardness Release

In another non-limiting embodiment, the glasscare active salt is released by the presence or absence of hardness. A hardness release mechanism relates to a coating that does not release in the built main wash, but releases in the calcium-rich rinse water. Poor disintegration under soft water conditions may require a second outer coating to prevent exposure of glasscare active salt until after hardness removal by the builders.

D. Interfacial Tension Release

In another non-limiting embodiment, the glasscare active salt is released due to the lack of surfactant or higher interfacial tension. An interfacial tension release mechanism relates to a coating that senses the lack of surfactants and dissolves during the higher interfacial tension rinse. Disintegration during the prewash cycle may require a second outer coating to prevent exposure of glasscare active salt until after surfactant dissolution.

E. Mechanical Action Release

In another non-limiting embodiment, the glasscare active salt is released by mechanical action. A mechanical action release mechanism relates to a coating that shears during the vigorous water spraying wash and/or rinse cycles. If release during the rinse cycle is desired, the at least one encapsulating coating could disintegrate during the main wash. Thus, a second outer coating may be provided to prevent exposure of glasscare active salt during the main wash.

F. pH-Sensitive Release

In another non-limiting embodiment, the glasscare active salt is released by a lower pH or a pH change. A pH-sensitive release mechanism relates to a coating that may, for example, remain insoluble during the alkaline main wash but disintegrates during the lower pH rinse cycle. Two types of pH-sensitive release mechanisms are: amine protonation and PVA-boric acid films.

1. pH-Sensitive Release via Amine Protonation

In one non-limiting embodiment, the glasscare active salt can be released via dissolution and/or disruption of the encapsulating coating comprising pH-sensitive materials undergoing amine protonation. The common theme behind this class of rinse-sensitive materials is the selection of an appropriate compound with amine groups of a specific pKa, which causes them to be deprotonated at pH 10, but protonated (and hence soluble) at pH 9.

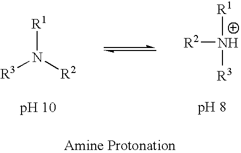

(a) pH-Sensitive Release via Polymers With Pendant Amine Groups

In one non-limiting embodiment, the encapsulated glasscare active salt can be released via dissolution and/or disruption of the encapsulating coating comprising pH-sensitive materials comprising polymers with pendant amine groups. Most polymers with pendant amine groups are PVA or polycarboxylate derivatives and are applied in ethanol solution. In the Japanese Patent Nos. 49098403 and 50077406, polymers with pendant amine groups are disclosed coatings containing carboxylic acids. In later Japanese Patent Nos. 60141705, 61028440, 61028441, 61028598, 61028597, and 61028596 similar polymers were used without carboxylic acids being present.

Commercially available polymer examples include EUDRAGIT E® and AEA SANKYO® polymers. EUDRAGIT E® polymer is a non-biodegradable, polymethacrylate polymer from Roehm Pharma GmbH, Darmstadt, Federal Republic of Germany. AEA SANKYO® polymer is a synthetic polymer containing triazine derivatives from Sankyo Company Limited, Tokyo, Japan. These polymers with pendant amine groups are formulated to disintegrate or dissolve in water

A natural material, chitosan, has also been shown to have similar properties.

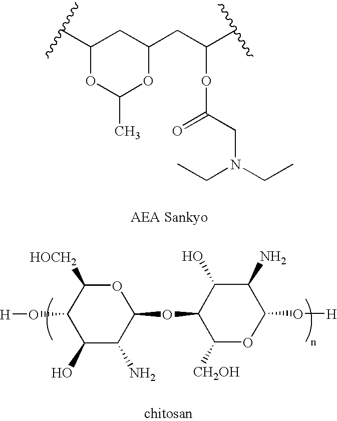

(b) Substituted Polyamines and Schiff-Base Materials

In another non-limiting embodiment, the encapsulated glasscare active salt is released via dissolution and/or disruption of the encapsulating coating comprising pH-sensitive materials comprising substituted polyamines and schiff-base materials.

A recent patent application, PCT Pub. No. WO 0017311 discloses the use of polyamine or triamine, such as N1-hydroxyethyl-N1,N2-dimethyl-N3-dodecyl-diethylenetriamine, as the release active in pH-sensitive films. It is disclosed that the presence of the dodecyl group enhances the film-forming properties of the material.

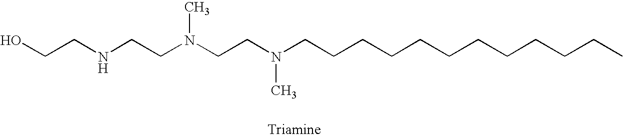

Similar results are obtained using the imine functionality as the pH-sensitive group. It is disclosed in PCT Pub. No. WO0017311 that Schiff-base materials derived from aromatic amines and aliphatic aldehydes are particularly suitable.

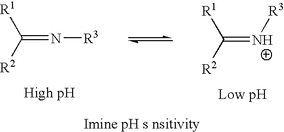

2. pH and Borate Sensitivity—PVA/Boric Acid Films

In another non-limiting embodiment, the encapsulated glasscare active salt is released via dissolution and/or disruption of the encapsulating coating comprising pH- and borate-sensitive materials comprising PVA/boric acid films. The complex between borate and PVA is most stable at high pH and high borate concentration, i.e. is sensitive to two properties, which differentiate rinse cycles from the prewash or main wash (in formulations where perborate or other borate source is present).

Boric acid can be introduced to the films to ensure stability at the start of the wash.

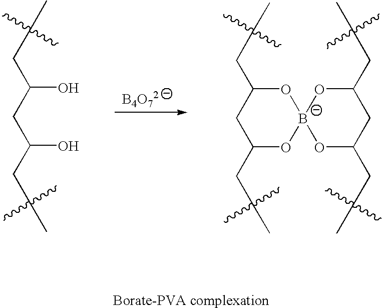

PVA/boric acid films are disclosed in the U.S. Pat. Nos. 4,082,678; and 4,801,636; and 4,972,017.

G. Ionic Strength-Sensitive Release

In another non-limiting embodiment, the glasscare active salt is released by ionic strength or a change in ionic strength. An ionic strength release mechanism relates to a coating that is sensitive to the overall level of electrolyte in solution, rather than a specific ion. A second outer coating may be provided to prevent premature dissolution during the wash cycle.

1. Ionic-Strength Sensitive Polymers

(a) Potassium Ion Sensitivity (\acute{K}-Carrageenan bipolymers)

In another non-limiting embodiment, the encapsulated glasscare active salt is released via dissolution and/or disruption of the encapsulating coating comprising ionic-strength sensitive materials comprising ionic-strength sensitive polymers, such as \acute{K}-Carrageenan bipolymers. The biopolymer \acute{K}-Carrageenan forms a stable complex with potassium ions and can therefore be used as part of a rinse-sensitive film in formulations containing a source of this ion. For example, PCT Pub. No. WO 00/06683 discloses the stability of the polymer-potassium complex is improved at elevated temperatures, helping to ensure the at least one encapsulating coating remains intact in a warm main wash.

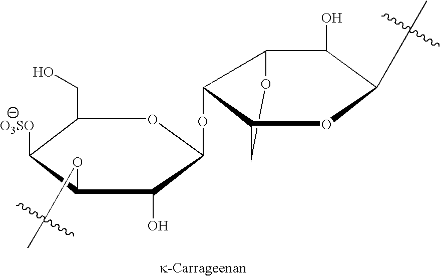

2. General Ionic Strength Sensitivity (Dilution) Release Mechanism

In another non-limiting embodiment, the glasscare active salt is released by dilution. A dilution release mechanism relates to dissolution of a coating based on the general ionic strength sensitivity of the at least one encapsulating coating. UK Pat. No. GB 1390503 discloses coating materials which are stable in concentrated electrolyte solutions but become soluble as ionic strength is reduced on dilution. Coating polymers disclosed include materials sensitive to specific ions or electrolytes in general. For example, coating polymers include various natural gums, pectins, cellulose ethers, PVA, and mixtures thereof.

### Rinse Aid Components

EGAS compositions can comprise traditional detergency components. The EGAS rinse aid compositions comprise at least one of the following: a surfactant, suds suppressor, carrier, hydrotrope, dispersant polymer, bleach, and mixtures thereof.

Surfactant

EGAS compositions may be provided with any suitable surfactant in any suitable amount. In EGAS compositions and methods of use in automatic dishwashing, the detergent surfactant may be a low foaming surfactant by itself or in combination with other components (i.e. suds suppressers). In compositions and methods for use in cleaning soiled glassware prior to dishwashing, the detergent surfactant may be a foamable surfactant in direct application but low foaming in automatic dishwashing use.

Surfactants suitable for use include, but are not limited to, anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, or C₁₀-C₁₈ linear or branched; cationic surfactants such as chlorine esters (U.S. Pat. No. 4,228,042; U.S. Pat. No. 4,239,660; and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants, and mixtures thereof including nonionic alkoxylated surfactants (especially ethoxylates derived from C₆-C₁₈ primary alcohols), ethoxylated-propoxylated alcohols (e.g., Olin Corporation's POLY-TERGENT® SLF18), epoxy-capped poly(oxyalkylated) alcohols (e.g., Olin Corporation's POLY-TERGENT® SLF18B—see PCT Pub. No. WO A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich.; amphoteric surfactants such as the C₁₂-C₂₀ alkyl amine oxides (for example, amine oxides suitable for use include, but are not limited to, lauryldimethyl amine oxide and hexadecyl dimethyl amine oxide), and alkyl amphocarboxylic surfactants such as MIRANOL™ C2M; and zwitterionic surfactants such as the betaines and sultaines; and mixtures thereof. Surfactants suitable for use are disclosed, for example, in U.S. Pat. No. 3,929,678, U.S. Pat. No. 4,259,217, EP Pat. No. 0414 549, PCT Pub. No. WO A-93/08876 and PCT Pub. No. WO A-93/08874.

Surfactants may be present at any level. In some embodiments, the surfactant is present at from about 0% to about 50% by weight, or from about 0.5% to about 10% by weight, or from about 1% to about 5% by weight of composition. In one non-limiting embodiment, the EGAS composition comprises from about 0% to about 30% by weight, a surfactant may comprise anionic surfactants, cationic surfactants, nonionic surfactants, amphoteric surfactants, ampholytic surfactants, zwitterionic surfactants, and mixtures thereof. In another non-limiting embodiment, the surfactant comprises at least one anionic and nonionic surfactant at a level of about 0.2% to about 30%, by weight.

Suds Suppressor

EGAS compositions may be provided with any suitable suds suppressor in any suitable amount. Suds suppressors suitable for use may be low foaming and include low cloud point nonionic surfactants and mixtures of higher foaming surfactants with low cloud point nonionic surfactants which act as suds suppressors therein (see PCT Pub. No. WO 93/08876 and EP Pat. No. 0705324).

Typical low cloud point nonionic surfactants which act as suds suppressors include nonionic alkoxylated surfactants, especially ethoxylates derived from primary alcohol, and polyoxypropylene/polyoxyethylene/polyoxypropylene (PO/EO/PO) reverse block polymers. Also, such low cloud point nonionic surfactants include, for example, ethoxylated-propoxylated alcohol (e.g., Olin Corporation's POLY-TERGENT® SLF18) and epoxy-capped poly(oxyalkylated) alcohols (e.g., Olin Corporation's POLY-TERGENT® SLF18B series of nonionics, as described, for example, in U.S. Pat. No. 5,576,281).

Low cloud point surfactants suitable for use are the ether-capped poly (oxyalkylated) suds suppressor having the formula:

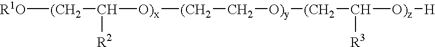

wherein R_{I} is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:

R_{I}O(R_{II}O)ₙCH(CH₃)OR_{III}

wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:

(i) a 4 to 8 membered substituted, or unsubstituted heterocyclic ring containing from 1 to 3 hetero atoms; and

(ii) linear or branched, saturated or unsaturated, substituted or unsubstituted, cyclic or acyclic, aliphatic or aromatic hydrocarbon radicals having from about 1 to about 30 carbon atoms;

provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C, to C₅ alkyl.

Suds suppressors may be present at any level. In some embodiments, the suds suppressor is present at from about 0% to about 30% by weight, or about 0.2% to about 30% by weight, or from about 0.5% to about 10% by weight, or from about 1% to about 5% by weight of composition. In a non-limiting embodiment, the EGAS composition comprises from about 0.2% to about 30% by weight of composition a low foaming suds suppressor.

Carrier

Any carrier of any type and in any amount may be used in the rinse aid composition. In addition to water, the carrier can contain a low molecular weight organic solvent that may be highly soluble in water, e.g., ethanol, methanol, propanol, isopropanol and the like, and mixtures thereof. Low molecular weight alcohols can allow the treated dish- and glassware surface to dry faster. The water-soluble low molecular weight solvent can also be used at a level of up to about 50%, typically from about 0.1% to about 25%, alternatively from about 2% to about 15%, alternatively from about 5% to about 10%, by weight of the suitable carrier medium. Factors that need to be considered when a high level of solvent is combined with the suitable carrier medium are odor, flammability, dispersancy and environmental impact.

Rinse aid compositions can also be in a “concentrated form”, in such case, the concentrated liquid rinse aid composition according one non-limiting embodiment will contain a lower amount of a suitable carrier medium, compared to conventional liquid rinse aid compositions. For example, the suitable carrier medium content of the concentrated system may, for example, be present in an amount from about 30% to about 99.99% by weight of the rinse aid composition. The dispersant content of the concentrated system rinse aid composition may, for example, be present in an amount from about 0.001% to about 10% by weight of the rinse aid composition.

Hydrotrope

Any suitable hydrotrope in any suitable amount may be used to make the rinse aid composition. Suitable hydrotropes include, but are not limited to, sodium benzene sulfonate, sodium toluene sulfonate, sodium cumene sulfonate, and mixtures thereof.

The following references disclose a wide variety of suitable hydrotropes: U.S. Pat. No. 6,130,194; U.S. Pat. No. 5,942,485; U.S. Pat. No. 5,478,503; U.S. Pat. No. 5,478,502; U.S. Pat. No. 6,482,786; U.S. Pat. No. 6,218,345; U.S. Pat. No. 6,191,083; U.S. Pat. No. 6,162,778; U.S. Pat. No. 6,152,152; U.S. Pat. No. 5,540,865; U.S. Pat. No. 5,342,549; U.S. Pat. No. 4,966,724; U.S. Pat. No. 4,438,024; and U.S. Pat. No. 3,933,671.

### Adjunct Materials

EGAS compositions may be provided with any suitable adjunct material in any suitable amount. In one non-limiting embodiment, the EGAS composition can comprise one or more adjunct materials comprising sodium-based anti-corrosion agents (e.g. sodium silicate), colorants (i.e. dyes, color speckles, and pigments), free radical inhibitors, polymers, anti-filming agents, anti-spotting agents, germicides, fungicides, bleaching system, bleach scavengers, general dishcare agents, and mixtures thereof.

### Product Form

The EGAS composition may be used in any physical form, e.g. solid, powders, liquid, paste, cream, gel, liquid gels, and combinations thereof, may be packaged in any form, for example a water soluble or water dispersible pouch, and combinations thereof, to deliver the glasscare active salt. The EGAS composition can also be in a form of a unit dose, which allows for the controlled release (for example delayed, sustained, triggered or slow release) of the glasscare active salt during the wash and/or rinse cycle of an automatic dishwashing appliance.

The EGAS composition can be in the form of a unit dose which allows for the controlled release (for example delayed, sustained, triggered or slow release) of the glasscare active salt during the wash and/or rinse cycle of an automatic dishwashing appliance. For example, the EGAS composition can be in the form of a solid, which allows the encapsulated glasscare active salt to be released during both the wash and/or rinse cycle.

Single- and multi-compartment water-soluble pouches may also be suitable for use. In the case of additive and multi-component products, the EGAS compositions do not need to be in the same physical form. In another non-limiting embodiment, the EGAS composition may be formulated in a multi-compartmental pouch so that optional bleaching systems can be used without the associated stain removal negative common to rinse aid composition having non-encapsulated glasscare active salt/bleach interaction.

In one non-limiting embodiment, the EGAS composition may be formulated as a gel to deliver an effective amount of an encapsulated glasscare active salt to the rinse without adverse interaction. In another non-limiting embodiment, the EGAS composition comprising encapsulated glasscare active salt could be designed to delay release of the glasscare active salt until the rinse cycle.

In yet another embodiment, EGAS compositions suitable for use can be dispensed from any suitable device, such as automatic dishwashing dispensers, bottles (pump assisted bottles, squeeze bottles), paste dispensers, capsules, multi-compartment bottles, multi-compartment capsules, and single- and multi-compartment water-soluble pouches, and combinations thereof.

### Method of Use

In one embodiment, a method of cleaning soiled glassware may comprise rinsing the glassware in an automatic dishwashing machine with an EGAS composition comprising (a) an encapsulated glasscare active salt comprising aluminum, zinc, magnesium, calcium, lanthanum, tin, gallium, strontium, titanium, and combinations thereof; (b) at least one rinse aid component comprising a surfactant, suds suppressor, carrier, hydrotrope, and mixtures thereof; and (c) optionally an adjunct material. The rinse aid may be present in any form including, but not limited to, liquid, liquid gel, gel, paste, cream, cast solid, powder, tablet, and mixtures thereof.

### Kit

In one embodiment, a kit may comprise (a) a package, (b) instructions for use, and (c) an EGAS composition suitable for use in automatic dishwashing comprising (i) an encapsulated glasscare active salt comprising aluminum, zinc, magnesium, calcium, lanthanum, tin, gallium, strontium, titanium, and combinations thereof; (ii) at least one rinse aid component comprising a surfactant, suds suppressor, carrier, hydrotrope, and mixtures thereof; and (iii) optionally an adjunct material.

The foregoing description can be provided to enable any person skilled in the art to make and use the invention, and can be provided in the context of a particular application and its requirements. Various modifications to the embodiments will be readily apparent to those skilled in the art, and the generic principles defined herein can be applied to other embodiments and applications without departing from the spirit and scope of the invention. The possible embodiments of this invention are not intended to be limited to the embodiments shown. Thus, since the following specific embodiments are intended only to exemplify, but in no way limit, the operation of the present invention, the present invention is to be accorded the widest scope consistent with the principles, features and teachings disclosed herein.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All molecular weights described herein are number average molecular weights.

All documents cited are, in relevant part, incorporated herein by reference; the citation of any document can be not to be construed as an admission that it can be prior art with respect to the present invention.

What is claimed is:

1. A rinse aid composition comprising:
a) from about 0.01% and about 70%, by weight of the composition of a glasscare active salt;
b) at least one rinse aid component; and
c) optionally an adjunct material;
wherein said glasscare active salt is at least partially encapsulated via at least one encapsulating agent which provides at least one encapsulating coating to said glasscare active salt.

2. A composition according to claim 1, wherein said glasscare active salt has at least one of the following properties:
a) nonfriable,
b) water-soluble,
c) water-dispersible,
d) dissolves, disperses, and/or melts in a temperature range of from about 40° C. to about 50° C.,
e) is a core particle, an aggregate of core particles, a prill, an agglomerate, and combinations thereof; and
f) combinations thereof.

3. A composition according to claim 1, wherein the release of said glasscare active salt to the wash and/or rinse liquor is triggered by the dissolution or disruption of said at least one encapsulating coating.

4. A composition according to claim 3, wherein said liquid composition delivers from about 0.1 mM to about 10 mM of said glasscare active salt or complex to the rinse liquor.

5. A composition according to claim 1, wherein said glasscare active salt comprises at least one of the following: aluminum, zinc, magnesium, calcium, lanthanum, tin, gallium, strontium, titanium, or combinations thereof.

6. A composition according to claim 5, wherein said glasscare active salt comprises at least one of the following: water-soluble aluminum salt, water-insoluble aluminum salt, slightly water-soluble aluminum salt, water-soluble zinc salt, water-insoluble zinc, slightly water-soluble zinc salt, water-soluble magnesium salt, water-insoluble magnesium salt, slightly water-soluble magnesium salt, water-soluble calcium salt, water-insoluble calcium salt, slightly water-soluble calcium salt, and mixtures thereof.

7 A composition according to claim 6, wherein said aluminum salt is aluminum sulfate.

8. A composition according to claim 1, wherein said at least one rinse aid component comprises at least one of the following: a surfactant, suds suppressor, carrier, hydrotrope, and mixtures thereof.

9. A composition according to claim 1, wherein said dissolution or disruption of said at least one encapsulating coating occurs via a release mechanism triggered by at least one of the following: time, temperature, hardness, interfacial tension, pH-sensitive, mechanical action, ionic strength, dilution, or combinations thereof.

10. A composition according to claim 1, wherein said at least one encapsulating agent comprises at least one of the following: fatty acids, polyvinyl alcohol, polyethylene glycols, builders, water-soluble cellulose and/or cellulose ether, polymers, polymer latex; polycarboxylate materials, ethylene vinyl acetate, polyvinyl alcohol, polyethylene waxes of melting point 50°-65° C., natural waxes, paraffin or microcrystalline waxes having melting points of 40°-94° C., liquid paraffin waxes, a alcohol waxes, synthetic resin, silicone oil, petroleum jelly, inorganic coatings, and mixtures thereof.

11 A composition according to claim 10, wherein said at least one encapsulating agent comprises at least one of the following: polymer, polymer latex, polycarboxylate material, ethylene vinyl acetate, polyvinyl alcohol, and mixtures thereof.

12. A composition according to claim 11, wherein said polymer comprises at least one of the following: natural gums, pectins, cellulose ethers, PVA, and mixtures thereof.

13. A rinse aid composition comprising:
a) from about 0.01% and about 70%, by weight of the composition of a glasscare active salt;
b) at least one rinse aid component; and
c) an adjunct material;
wherein said composition is in the form of a cast solid, powder, tablet, and mixtures thereof; wherein said glasscare active salt is at least partially encapsulated via at least one encapsulating agent which provides at least one encapsulating coating to said glasscare active salt; and wherein said encapsulating coating is substantially free of low critical solution temperature polymers.

14. A composition according to claim 13, wherein said glasscare active salt is in the form of a core particle, aggregate of core particles, prill, agglomerate, and mixtures thereof and is nonfriable, water-soluble or water dispersible or which dissolve, disperse or melt in a temperature range of from about 40° C. to about 50° C.

15. A composition according to claim 13, wherein the release of said glasscare active salt to the wash and/or rinse liquor is triggered by the dissolution or disruption of said at least one encapsulating coating.

16. A composition according to claim 15, wherein said liquid composition delivers from about 0.1 mM to about 10 mM of said glasscare active salt or complex to the rinse liquor.

17. A composition according to claim 13, wherein said glasscare active salt comprises at least one of the following: aluminum, zinc, magnesium, calcium, lanthanum, tin, gallium, strontium, titanium, or combinations thereof.

18. A composition according to claim 17, wherein said glasscare active salt comprises at least one of the following: water-soluble aluminum salt, water-insoluble aluminum salt, slightly water-soluble aluminum salt, water-soluble zinc salt, water-insoluble zinc, slightly water-soluble zinc salt, water-soluble magnesium salt, water-insoluble magnesium salt, slightly water-soluble magnesium salt, water-soluble calcium salt, water-insoluble calcium salt, slightly water-soluble calcium salt, and mixtures thereof.

19 A composition according to claim 18, wherein said aluminum salt is aluminum sulfate.

20. A composition according to claim 13, wherein said at least one rinse aid component comprises at least one of the following: a surfactant, suds suppressor, carrier, hydrotrope, and mixtures thereof.

21. A composition according to claim 13, wherein said dissolution or disruption of said at least one encapsulating coating occurs via a release mechanism triggered by at least one of the following: time, temperature, hardness, interfacial tension, pH-sensitive, mechanical action, ionic strength, dilution, and combinations thereof.

22. A composition according to claim 13, wherein said at least one encapsulating agent is selected from group consisting of fatty acids, polyvinyl alcohol, polyethylene glycols, builders, water-soluble cellulose, non-low critical solution polymer, polymer latex; polycarboxylate materials, ethylene vinyl acetate, polyvinyl alcohol, polyethylene waxes of melting point 50°-65° C, natural waxes, paraffin or microcrystalline waxes having melting points of 40°-94° C., liquid paraffin waxes, a alcohol waxes, synthetic resin, silicone oil, petroleum jelly, inorganic coatings, and mixtures thereof.

23 A composition according to claim 22, wherein said at least one encapsulating agent comprises at least one of the following: non-low critical solution polymer, polymer latex, polycarboxylate material, ethylene vinyl acetate, polyvinyl alcohol, and mixtures thereof.

24. A composition according to claim 23, wherein said non-low critical solution polymer is substantially free of alkylated and/or hydroxyalkylated polysaccharides, cellulose ethers, polyisoproplylacrylamine, copolymers of polyisopropylacrylamide, and mixtures thereof.

25. A composition according to claim 1, wherein said composition is in the form of a unit dose which allows for the controlled release of said encapsulated glasscare active salt during the wash and/or rinse cycle of said automatic dishwashing appliance; wherein said unit dose is provided as a single or multi-compartment water-soluble pouch.

26. A composition according to claim 13, wherein said composition is in the form of a unit dose which allows for the controlled release of said glasscare active salt during the wash and/or rinse cycle of said automatic dishwashing appliance; wherein said unit dose is provided as a tablet, single or multi-compartment water-soluble pouch, and combinations thereof.

27. A method of rinsing and protecting glassware comprising the step of rinsing said glassware in an automatic dishwashing machine with a rinse aid composition according to claim 1.

28. A method of rinsing and protecting glassware comprising the step of rinsing said glassware in an automatic dishwashing machine with a rinse aid composition comprising:
a) an encapsulated glasscare active salt comprising aluminum, zinc, magnesium, calcium, lanthanum, tin, gallium, strontium, titanium, and combinations thereof;
b) at least one rinse aid component comprising a surfactant, suds suppressor, carrier, hydrotrope, and mixtures thereof; and
d) optionally an adjunct comprising sodium-based anti-corrosion agents, dyes, colorants, free radical inhibitors, polymers, anti-filming agents, anti-spotting agents, germicides, fungicides, bleaching system, bleach scavengers, general dishcare agents, and mixtures thereof;
wherein said composition is in the form of a cast solid, powder, tablet, and mixtures thereof; wherein said glasscare active salt is at least partially encapsulated via at least one encapsulating agent which provides at least one encapsulating coating to said glasscare active salt; and wherein said encapsulating coating is substantially free of low critical solution temperature polymers.

29. A kit comprising:
(a) a package;
(b) instructions for use; and
(c) a rinse aid composition comprising:
(i) an encapsulated glasscare active salt comprising aluminum, zinc, magnesium, calcium, lanthanum, tin, gallium, strontium, titanium, and combinations thereof;
(ii) at least one rinse aid component comprising a surfactant, suds suppressor, carrier, hydrotrope, and mixtures thereof; and
(iii) optionally an adjunct material;
wherein said composition delivers from about 0.1 mM to about 10 mM of the glasscare active salt or complex in the wash and/or rinse cycle; wherein said composition is a cast solid, powder, liquid, liquid-gel, gel, and mixtures thereof; wherein when said composition is a cast solid or powder, said solid composition is substantially free of low critical solution temperature polymers; and wherein said composition is optionally provided as a tablet or contained in a single or multi-compartment water-soluble pouch.
